(19) United States
(12) Patent Application Publication
(10) Pub. No.: US 2008/0235808 A1
(43) Pub. Date: Sep. 25, 2008

(54) Method and Apparatus for Protection of Content Using Biometric Watermarks

(76) Inventors: Srinivas Gutta, Veldhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/586,078

(22) PCT Filed: Jan. 17, 2005
(86) PCT No.: PCT/IB2005/050192

§ 371 Date: Jul. 14, 2006

Related U.S. Application Data
(60) Provisional application No. 60/537,807, filed on Jan. 20, 2004.

(51) Int. Cl. H04L 9/32

(52) U.S. Cl. 726/28

(57) ABSTRACT

A method and apparatus are that restrict access to digital content to an authorized user on one or more systems using biometric watermarks. The disclosed biometric watermarking techniques allow an authorized user to be uniquely identified. Access to digital content is restricted to digital content in accordance with the present invention by embedding a biometric watermark, such as a biometric image, in the content. Thereafter, a user can only access the content if a biometric sample of the user matches the embedded biometric watermark. In one variation, the user can only access the content if the biometric sample is a live biometric sample. The embedded biometric watermark optionally includes information describing a system employed by the user to obtain the content. The user can optionally be permitted to access the content, without a biometric evaluation, if the content is on a system that has been previously authorized for the user using a biometric evaluation.

The present invention relates to methods and systems for the protection of digital content through the use of watermark techniques, and more particularly, for encoding, detecting and verifying watermarks that include biometric information.

Watermarks are embedded signatures in content (e.g., video and audio content) to verify the source of the material. This enables the owners and distributors of content to control and protect their copyrights and other ownership interests, and to control the distribution of the content. The goal of a digital watermark system is to embed an information signal or signals in the content such that there are few or no artifacts in the underlying content signal, while maximizing the encoding level and location sensitivity such that any attempt to remove the watermark will cause damage to the content signal. Generally, a digital watermark is difficult to remove because it shares many of the characteristics of random or pseudo-random noise within the digital content.

Watermarked digital content is typically embedded with a payload of information within the watermark, such as the names of the content author and content distributor. When the watermarked content is accessed by a device that has a watermark detection capability, such as a DVD player, a search for the watermark and evaluation of the watermark payload information is typically performed utilizing a watermark detection technique that is associated with that type of watermark. If the proper watermark is found, the device will permit play-out of the content. If the watermark is not detected or a corrupted watermark is detected, however, the device will not permit access to the watermarked content. Thus, the illegal reproduction and distribution of content will be prohibited.

The widespread use of the Internet has provided an additional outlet for the purchasing and downloading of multimedia content. However, peer-to-peer file sharing causes additional problems, such as content piracy. Digital watermarking and encryption techniques have been used to protect content and reduce piracy attributed to peer-to-peer file sharing. For example, if a first user legally, obtains an encrypted file, the user has the key for decoding the content. To prevent the first user plans from sharing the content and associated key with a second user, the content is typically encoded with additional information, such as attributes of the system used by the first user, such as a serial number uniquely identifying the processor or operating system (or both). Unfortunately, however, the first user can no longer access the content on another system.

A need therefore exists for a method and apparatus for limiting access to content to an authorized user on a number of systems. A further need exists for a digital watermarking technique that allows an authorized user to be uniquely identified.

Generally, a method and apparatus are that restrict access to digital content to an authorized user on one or more systems using biometric watermarks. The disclosed biometric watermarking techniques allow an authorized user to be uniquely identified. Access to digital content is restricted to digital content in accordance with the present invention by embedding a biometric watermark, such as a biometric image, in the content. Thereafter, a user can only access the content if a biometric sample of the user matches the embedded biometric watermark. In one variation, the user can only access the content if the biometric sample is a live biometric sample.

The embedded biometric watermark optionally includes information describing a system employed by the user to obtain the content. The user can optionally be permitted to access the content, without a biometric evaluation, if the content is on a system that has been previously authorized for the user using a biometric evaluation.

A more complete understanding of the present invention, as well as further features and advantages of the present invention, will be obtained by reference to the following detailed description and drawings.

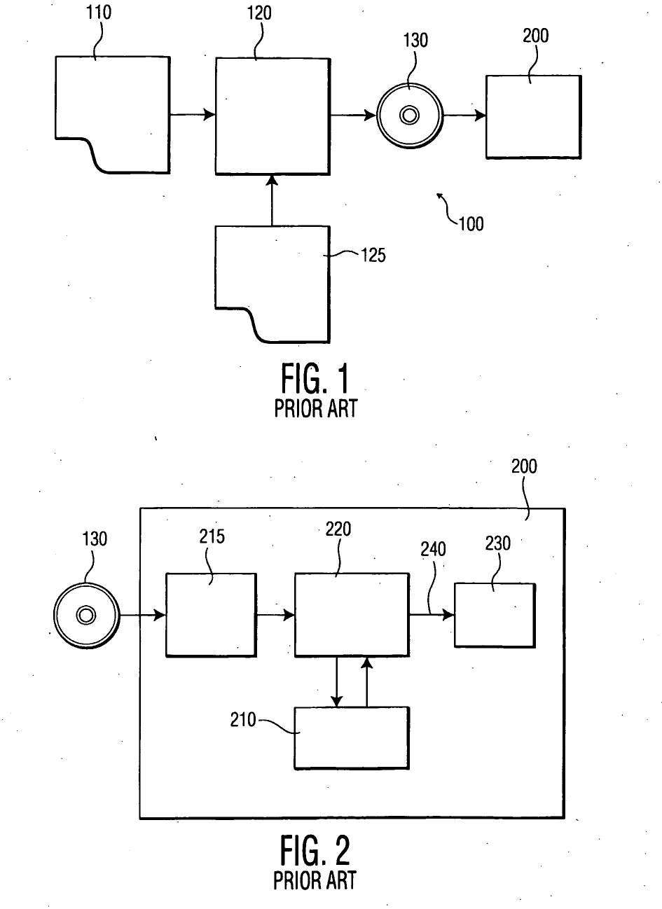

FIG. 1 illustrates a conventional system for embedding and detecting watermarks in digital content;

FIG. 2 illustrates a conventional content access device incorporating features of the present invention;

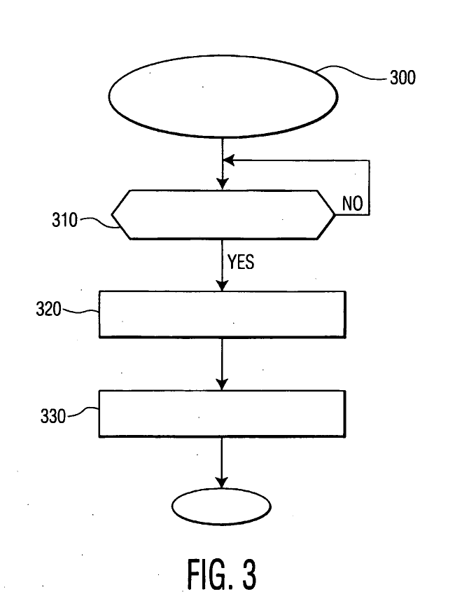

FIG. 3 is a flow chart of an exemplary watermark encoding process incorporating features of the present invention; and

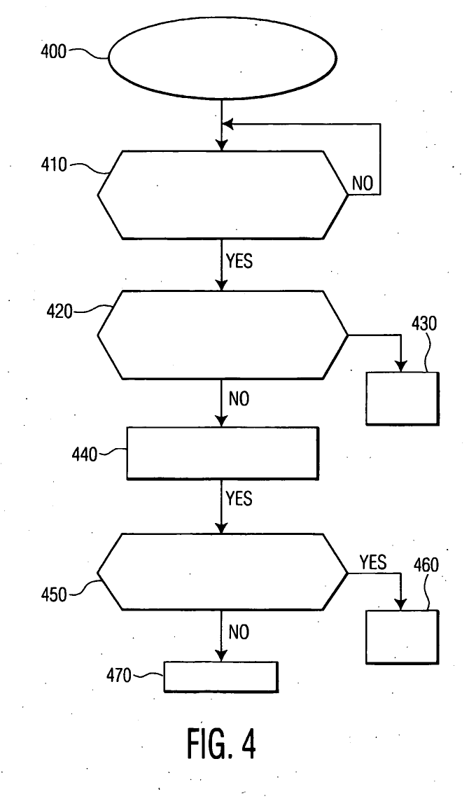

FIG. 4 is a flow chart of an exemplary watermark detection process incorporating features of the present invention.

FIG. 1 illustrates a conventional watermark encoding and detection system 100. Content data 110 is processed by watermark encoding processor 120 to add a watermark 115 to the content data 110. Algorithms for embedding watermarks are well known in the art. For a detailed discussion of a suitable watermark encoding algorithm, see, for example, International Patent No. WO 08/091375, entitled “Waternarking,” incorporated by reference herein. The watermarked content 130 is then distributed via one or more of methods, including networks, DVDs, or CDs (or a combination of the foregoing). A content access device 200, discussed further below in conjunction with FIG. 2, such as a DVD player, is then utilized to play-out the watermarked content 130.

FIG. 2 illustrates a conventional content access device 200. The content access device 200 may be embodied, for example, as any conventional content access device, such as a commercially available DVD player, as modified herein to provide the features and functions of the present invention. As shown in FIG. 2, content data input device 215 accesses content data 130 for presentation, for example, from memory, a DVD or CD. The output device 230 may be, for example, a display or speaker (or a combination thereof) for presenting visual or audio information, respectively. Content data processor 220 transforms the content data 130 for display by output device 230. As the content data 130 is accessed, watermark detector 210 repeatedly searches for a valid watermark 115. A valid watermark 115 is a watermark that has not been altered beyond a specified threshold from its original form. If a valid watermark 115 with its proper payload is detected, watermark detector 210 signals content data processor 220 to continue to process and output content data 240. If watermark detector 210 detects a corrupted watermark 115 (or an improper watermark payload), watermark detector 210 signals content data processor 220 to halt the play-out of output content data 240. A corrupted watermark 115 is a watermark that has been transformed from its original form by one or more techniques, such as rotating the original watermark 90 degrees from its initial orientation. For a more detailed discussion of suitable techniques for detecting watermarks in content, see, for example, International Patent No. WO 01/91461, entitled “Watermark Detection,” incorporated by reference herein.

According to one aspect of the present invention, access to multimedia content is restricted using biometric watermarks. For example, when a first user legally obtains a copy of the content from a service provider, a biometric associated with the first user is embedded into the content. The biometric watermark may include, for example, a finger print, speech pattern, iris pattern, or facial image. Since biometrics taken from the same user at different times vary and their recognition is not guaranteed, multiple instances of the biometric can be taken and embedded into the content.

In one exemplary implementation, when a user obtains content, a biometric identifier is obtained from the user, as well as one or more parameters identifying a system of the user. Each time the biometric is embedded into the content, the system information can also be embedded. Thereafter, whenever the user attempts to access the content, the user is requested to provide a biometric identifier. The provided biometric information is compared to the biometric information embedded in the content. If the provided biometric information matches the embedded biometric information, the user will be allowed to access the content. In this manner, the authorized user cannot share the content with another user, since the second user generally would not have the biometric or system information of the authorized user.

According to a further aspect of the present invention, the user can transfer the downloaded content to a different system, by satisfying a biometric evaluation on the new machine. In one variation of the invention, once the content is authorized for the user on a given system, further biometric comparisons can optionally be suspended whenever the same content is played on the same system. The present invention provides a mechanism for identifying the user that has been the source of pirated content.

In yet another variation, the authorized user can be required to provide a “live” biometric. In other words, the present invention can ensure that the authorized user is providing a live biometric and not a biometric that has been previously stored. For a discussion of suitable techniques for detecting if a biometric is live, see, for example, R. Derakhshani et al. “Determination of Vitality from a Non-Invasive Biomedical Measurement for use in Fingerprint Scanners,” Pattern Recognition, vol. 17, no. 2, (2003), or S. A. C. Schuckers, “Spoofing and Anti-Spoofing Measures,” http://www.citer.wvu.edu/members/publications/files/15-SSchuckers-Elsevior02.pdf (Dec. 20, 2002) (and references cited therein), each incorporated by reference herein.

FIG. 3 is a flow chart describing an exemplary implementation of a watermark encoding process 300 in accordance with the present invention. The watermark encoding process 300 can be performed by the watermark encoding processor 120 of FIG. 1 to insert a watermark into content data 110. As shown in FIG. 3, the watermark encoding process 300 is initiated during step 310 when a user requests to obtain a copy of the content 110. Biometric and system information are obtained from the user during step 320. The obtained biometric watermark may include, for example, a finger print, speech pattern, iris pattern, or facial image. The biometric and system information are embedded in the content during step 330 using known watermarking techniques, such as those described in International Patent No. WO 08/091375, entitled “Watermarking.” Generally, the biometric image can be treated like any image, such as a corporate logo, for which well known techniques exist for embedding image-based watermarks in content. As previously indicated, multiple instances of the biometric can optionally be taken and embedded into the content.

FIG. 4 is a flow chart describing an exemplary implementation of a watermark detection process 400 in accordance with the present invention. The watermark detection process 400 can be performed by the watermark detector 210 of FIG. 2. As shown in FIG. 4, the watermark detection process 400 is initiated during step 410 when a user attempts to access content protected by a biometric watermark in accordance with the present invention. A test is performed during step 420 to determine if the content has previously been authorized on the current system, using, for example, the system parameters that were embedded into the biometric watermark. If it is determined during step 420 that the content has previously been authorized on the current system, then the user is allowed to access the content during step 430.

If, however, it is determined during step 420 that the content has not previously been authorized on the current system, then a live biometric is obtained from the user during step 440. A further test is performed during step 450 to determine if the live biometric matches the biometric that was embedded in the content as a biometric watermark. If it is determined during step 450 that the live biometric matches the biometric that was embedded in the content as a biometric watermark, then the user is allowed to access the content during step 460. In addition, the system parameters for the new system can optionally be embedded in a new biometric watermark in the content. If, however, it is determined during step 330 that the live biometric does not match the biometric that was embedded in the content as a biometric watermark, then the user is not allowed to access the content and program control terminates during step 470.

It is to be understood that the embodiments and variations shown and described herein are merely illustrative of the principles of this invention and that various modifications may be implemented by those skilled in the art without departing from the scope and spirit of the invention.

1. A method for restricting access to content, comprising the steps of:
embedding a biometric watermark in said content; and
providing access to a user of said content if a biometric sample of said user matches said embedded biometric watermark.

2. The method of claim 1, wherein said embedded biometric watermark includes a biometric image.

3. The method of claim 1, wherein said providing step further comprises the step of determining if said biometric sample is a live biometric.

4. The method of claim 1, wherein said embedded biometric watermark includes information describing a system employed by said user to obtain said content.

5. The method of claim 4, wherein said providing step further comprises the step of evaluating one or more parameters of a system employed by said user to access said content.

6. The method of claim 4, wherein said providing step further comprises the step of providing access to said content if said content is on a system that has been previously, authorized for said user.

7. The method of claim 1, further comprising the step of disabling access to said content if said biometric sample of said user does not match said embedded biometric watermark.

8. A system for restricting access to content, comprising:
a memory; and
at least one processor, coupled to the memory, operative to:
embed a biometric watermark in said content; and
provide access to a user of said content if a biometric sample of said user matches said embedded biometric watermark.

9. The system of claim 7, wherein said embedded biometric watermark includes a biometric image.

10. The system of claim 7, wherein said providing step further comprises the step of determining if said biometric sample is a live biometric.

11. The system of claim 7, wherein said embedded biometric watermark includes information describing a system employed by said user to obtain said content.

12. The system of claim 10, wherein said providing step further comprises the step of evaluating one or more parameters of a system employed by said user to access said content.

13. The system of claim 10, wherein said providing step further comprises the step of providing access to said content if said content is on a system that has been previously authorized for said user.

14. The method of claim 1, wherein said processor is further configured to disable access to said content if said biometric sample of said user does not match said embedded biometric watermark.

15. An article of manufacture for restricting access to content, comprising a machine readable medium containing one or more programs which when executed implement the steps of:
embedding a biometric watermark in said content; and
providing access to a user of said content if a biometric sample of said user matches said embedded biometric watermark.

16. The article of manufacture of claim 13, wherein said embedded biometric watermark includes a biometric image.

17. The article of manufacture of claim 13, wherein said providing step further comprises the step of determining if said biometric sample is a live biometric.

18. The article of manufacture of claim 13, wherein said embedded biometric watermark includes information describing a system employed by said user to obtain said content.

19. The article of manufacture of claim 16, wherein said providing step further comprises the step of evaluating one or more parameters of a system employed by said user to access said content.

20. The article of manufacture of claim 17, wherein said providing step further comprises the step of providing access to said content if said content is on a system that has been previously authorized for said user.
